(19) United States
(12) Patent Application Publication
(10) Pub. No.: US 2010/0262490 A1
(43) Pub. Date: Oct. 14, 2010

(54) SERVER APPARATUS, METHOD OF PRODUCING ADVERTISEMENT INFORMATION, AND PROGRAM

(75) Inventors: Akihiko Ito, Kanagawa (JP); Kazuhiro Fukuda, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Tokyo (JP)

(21) Appl. No.: 12/723,859

(22) Filed: Mar. 15, 2010

(30) Foreign Application Priority Data
Apr. 10, 2009 (JP) 2009-096228

(51) Int. Cl. G06Q 30/00

(52) U.S. Cl. 705/14.49

(57) ABSTRACT

A server apparatus includes a first storage, a second storage, a communication section, and a controller. The first storage stores an area image that is extracted from at least one area included in a content and first metadata that indicates information on the area in association with each other. The second storage stores advertisement material information on one of a product and a service. The communication section receives first input information that is input in a client apparatus to search for one of the product and the service, from the client apparatus via a network. The controller extracts the first metadata associated with the received first input information and produces combined advertisement information by combining the area image associated with the extracted first metadata and the stored advertisement material information with each other, the combined advertisement information being to be displayed in the client apparatus.

### BACKGROUND OF THE INVENTION

1. Field of the Invention

The present invention relates to a server apparatus capable of producing advertisement information of a product or a service in combination with contents of media data such as various types of books including comic books and magazines, moving images, and still images, and a method of producing advertisement information for the server apparatus, and a program therefor.

2. Description of the Related Art

From the past, there are digital books obtained by digitizing books such as comic books and paper-based magazines published by publishers and making the books viewable in electronic apparatuses such as PCs (Personal Computers) and cellular phones (digital comics and digital magazines). Such digital books have a merit that publishers can provide contents to readers at low costs as compared to the case of providing paper-based publications, and are therefore increasingly prevailing.

Incidentally, a space of a part of a digital magazine is sold to an advertiser and used for inserting advertisement information of a product or a service, as in a case of a paper-based magazine. However, as compared to the magazine in which a plurality of different articles are inserted at random, digital comics and digital novels are not suitable for providing advertisement information from the viewpoint of an effect thereof due to a character of the media in which one story is sequentially read through from the beginning to the end. Further, in a case where other books such as a picture book, a photo collection book, an art collection book, a technical book, and a map are digitized, those digital books are not suitable for providing advertisement information in view of their artistic value and practical value. Moreover, though advertisement information is generally inserted into the beginning of or between video contents, the video contents themselves are not displayed when the advertisement information is displayed. As a result, it is difficult for a viewer to directly associate details of the video contents with details of the advertisement information.

Japanese Patent Application Laid-open No. 2002-150316 (paragraph [0129] etc.; hereinafter, referred to as Patent Document 1) discloses an interactive advertisement production system in which advertising information that is produced by incorporating specific production information into general-purpose model software and library software is scheduled so as to appear in spots in intervals of data broadcast programs such as comics.

### SUMMARY OF THE INVENTION

However, in a case where advertisement information is provided in intervals of digital comics provided as data broadcast programs as in the case of Patent Document 1, a reader (viewer) feels uncomfortable because the advertisement information interrupts the viewing of the digital comics. In addition, in a case where the system of Patent Document 1 is applied to a digital comic that is downloaded by a user and can be viewed manually by the user, questions remain as to whether the advertisement information inserted in intervals of digital comics is viewed by the user. Therefore, the advertisement information is incapable of exerting its effect in this case.

On the other hand, characters and speeches in comics and their scenes respectively have unique perspectives of the world. It is desired to establish a system capable of enhancing advertising value by using such valuable perspectives of the world for advertising. Moreover, not only comics, materials constituting other books such as a magazine, a picture book, a photo collection book, an art collection book, a technical book, and a map or scenes of a video each have value as information sources and a synergistic effect thereof in combination with the advertisement information can be expected.

In view of the circumstances as described above, there is a need for a server apparatus, a method of producing advertisement information, and a program that are capable of effectively utilizing value of respective portions of various contents as an information sources and enhancing an advertising effect of a product or a service.

According to an embodiment of the present invention, there is provided a server apparatus including a first storage, a second storage, a communication section, and a controller. The first storage stores an area image that is extracted from at least one area included in a content and first metadata that indicates information on the area in association with each other. The second storage stores advertisement material information on one of a product and a service. The communication section receives first input information that is input in a client apparatus to search for one of the product and the service, from the client apparatus via a network. The controller extracts the first metadata associated with the received first input information and produces combined advertisement information by combining the area image associated with the extracted first metadata and the stored advertisement material information with each other, the combined advertisement information being to be displayed in the client apparatus.

Here, the content refers to all electronic media such as digital books including a comic, a magazine, a picture book, a photo collection book, a novel with an illustration, a poetry book, an art collection book, a technical book, and a map, a video, and a Web site. The area refers to, for example, a frame or page of a comic, an article and a photo of a magazine, a text and an illustration of a novel, a poem of a poetry book, a photo and a text of a picture book and a photo collection book, a painting and a text of an art collection book, a text and an illustration of a technical book, a part of a map, a text and an image of a Web site, and a scene of a video. The first metadata also includes, in addition to the image information and letter information that can be directly acquired from the area image described above, information of an attribute, a status, a background, and the like of the image information and letter information. For example, in a case where the content is a comic, the first metadata includes information that can be directly recognized from a frame, such as letter information such as a speech, a narration, and a telop, and a picture of a character. In addition, the first metadata includes indirect information that can be input by an image/letter analysis or manually, such as a character name, the number of characters, a geographical name or facility name of a scene in a frame, an action of a character, feeling, an atmosphere of a frame, a name of an object that appears in a frame, and an impression of a speech. The first input information may be a keyword such as a name of a product or service, a category name, and a word indicating feelings of taste, eyesight, and the like. The first input information may be input by a general consumer who is considering purchasing the product of service, or may be input by an agent who is considering selling the product or service. In a case where the produced combined advertisement information is viewed by a general consumer through the client apparatus, the server apparatus may execute settlement processing for purchasing and selling the product or service through e-commerce. The first storage and the second storage may be an independent storage device, or may be provided in the same storage device.

With this structure, the server apparatus can produce the combined advertisement information having a high advertising effect in which value of the content as an information source is effectively used, by combining the area image and advertisement material information of the content with each other based on the first input information. Accordingly, by prompting an advertiser to use the combined advertisement information, the server apparatus can contribute to an increase in sales of a product or service of the advertiser.

The communication section may receive second metadata indicating attribute information of the content from an external apparatus via the network. In this case, the controller may produce the combined advertisement information so that the received second metadata is displayed together with the area image and the advertisement material information in the client apparatus.

Accordingly, by incorporating the attribute information of the content into the combined advertisement information, the server apparatus can evoke user's appetite for purchasing to not only a product or service as an advertisement target of the advertisement material information but also comics. In this case, the server apparatus may execute settlement processing for purchasing and selling the content through e-commerce with the client apparatus. Further, by the combined advertisement information, the server apparatus can provide the advertisement information associated with the content to a user interested in that content, and also evoke appetite for purchasing a product or service. The attribute information is, for example, a content name, an author name, a thumbnail.

The area may include one of image information and letter information, and the first metadata may indicate information on one of the image information and the letter information. In this case, the first storage may plurally store the area image and the first metadata in association with each other. In this case, the communication section may transmit the produced combined advertisement information together with the first metadata to the client apparatus so that the produced combined advertisement information is displayed in the client apparatus. Moreover, the communication section may receive, from the client apparatus, first designation information that designates one of the image information and the letter information included in the combined advertisement information displayed in the client apparatus based on the transmitted first metadata. In this case, the controller may separately produce, based on the received first designation information, the combined advertisement information associated with the first designation information and transmit the separately-produced combined advertisement information to the client apparatus by the communication section.

Accordingly, the server apparatus can make a link from a piece of combined advertisement information to another piece of combined advertisement information based on the image information or letter information designated by a user of the client apparatus. As a result, the server apparatus can expand user's appetite for purchasing to more products or services. In this case, the server apparatus may transmit a list of other pieces of combined advertisement information to the client apparatus to select combined advertisement information to be displayed. The image information is, for example, a picture of a character, a photo, an illustration, a map, and a part of a video. The letter information is, for example, a speech, a narration, a telop, a poem, and an explanatory text.

The server apparatus may further include a third storage to store third metadata on a different content associated with one of the content and the first metadata in association with the second metadata. In this case, the communication section may receive, from the client apparatus, second designation information that designates the second metadata included in the combined advertisement information displayed in the client apparatus. In this case, the controller may transmit, based on the received second designation information, the third metadata associated with the second metadata to the client apparatus by the communication section so that the third metadata is linked from the second metadata and displayed.

Accordingly, the server apparatus can direct a user of the client apparatus to not only the advertisement information of a product or service and the information of a content associated therewith but also a content associated with the comic and the first metadata, and thus can evoke user's interests to the content.

Here, examples of the different content include music such as a composition and a talk, in addition to those described above. The third metadata may be information for viewing, programming of viewing, and programming of recording of those different contents as broadcast programs. Further, the third metadata may be information for purchasing those different contents as media such as a DVD, a BD (Blu-ray Disc), and a CD (Compact Disc) or on-demand videos, link information to a Web site, and the like.

The server apparatus may further include a third storage to store condition information that indicates a condition on a combination of the advertisement material information and a pair of the area image and the second metadata. In this case, the controller may produce the combined advertisement information based on the condition information.

Accordingly, the server apparatus can reflect an intention of an advertiser or content holder of the advertisement material information in the combined advertisement information and prevent combined advertisement information that is not intended by the advertiser or content holder from being produced.

Here, the condition information may be information designated in advance by the advertiser or content holder, or may be information produced by the server apparatus in accordance with a kind of business or the like of the advertiser.

The controller may produce a list of the area images associated with the first input information before the combined advertisement information is produced, and transmit the produced list to the client apparatus by the communication section. Further, the controller may receive selection information that indicates a selection of at least one area image from the transmitted list and the advertisement material information to be stored in the second storage from the client apparatus by the communication section. Then, the controller may produce the combined advertisement information based on the received selection information and the received advertisement material information.

Accordingly, the server apparatus transmits, as a list, the plurality of area images to be combined with the advertisement material information to the client apparatus and prompts a user to select one from the list, thus producing the combined advertisement information that matches the intention of the advertiser.

According to another embodiment of the present invention, there is provided a method of producing advertisement information, including storing an area image that is extracted from at least one area included in a content and first metadata that indicates information on the area in association with each other. Further, the method of producing advertisement information includes storing advertisement material information on one of a product and a service. Input information that is input in a client apparatus to search for one of the product and the service is received from the client apparatus via a network. The first metadata associated with the received input information is extracted. The area image associated with the extracted first metadata and the stored advertisement material information are combined with each other, and combined advertisement information that is displayed in the client apparatus is displayed.

According to still another embodiment of the present invention, there is provided a program causing a server apparatus to execute a first storage step, a second storage step, a reception step, an extraction step, and a production step. The first storage step includes storing an area image that is extracted from at least one area included in a content and first metadata that indicates image information and letter information included in the area in association with each other. The second storage step includes storing advertisement material information on one of a product and a service. The reception step includes receiving input information that is input in a client apparatus to search for one of the product and the service, from the client apparatus via a network. The extraction step includes extracting the first metadata associated with the received input information. The production step includes producing combined advertisement information that is displayed in the client apparatus by combining the area image associated with the extracted first metadata and the stored advertisement material information with each other.

As described above, according to the embodiments of the present invention, it is possible to effectively utilize value of the respective portions of various contents as information sources and enhance an advertising effect of a product or service.

These and other objects, features and advantages of the present invention will become more apparent in light of the following detailed description of best mode embodiments thereof, as illustrated in the accompanying drawings.

### BRIEF DESCRIPTION OF DRAWINGS

FIG. 1 is a diagram showing a general outline of an advertisement system in an embodiment of the present invention;

FIG. 2 is a diagram showing a structure of an advertisement server according to the embodiment of the present invention;

FIG. 3 is a diagram showing a structure of a database used in the advertisement system in the embodiment of the present invention;

FIG. 4 is a sequence diagram showing a flow of processing up until when a configuration of advertisement unit information is determined in the embodiment of the present invention;

FIG. 5 is a diagram showing a display example of the advertisement unit information produced in the embodiment of the present invention;

FIG. 6 is a sequence diagram showing a flow of advertisement-unit-information-providing processing in the embodiment of the present invention;

FIG. 7 is a sequence diagram showing a flow of speech link processing in the embodiment of the present invention;

FIG. 8 is a diagram showing a display example of a screen during execution of the speech link processing in the embodiment of the present invention;

FIG. 9 is a sequence diagram showing a flow of character link processing in the embodiment of the present invention;

FIG. 10 is a diagram showing a display example of a screen during execution of the character link processing in the embodiment of the present invention;

FIG. 11 is a diagram showing a flow of an operation of a page-content-linking advertisement system in another embodiment of the present invention;

FIG. 12 is a diagram showing a display example of comic data and an advertisement material displayed in the page-content-linking advertisement system in the embodiment of the present invention; and

FIG. 13 is a diagram showing a display example of comic data and an advertisement material displayed in a page-content-linking advertisement system in still another embodiment of the present invention.

### DESCRIPTION OF PREFERRED EMBODIMENTS

Hereinafter, embodiments of the present invention will be described with reference to the drawings.

### [General Outline of Advertisement System]

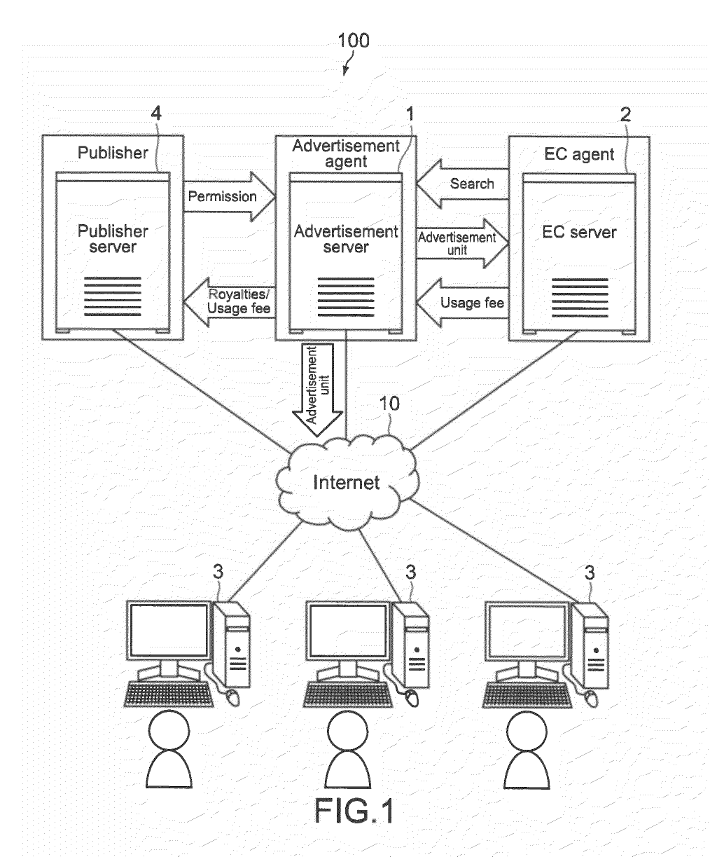

FIG. 1 is a diagram showing a general outline of an advertisement system in an embodiment of the present invention. In this embodiment, a case where comics are used as an example of contents will be described.

As shown in FIG. 1, an advertisement system 100 includes an advertisement server 1, an EC (Electronic Commerce) server 2, clients 3, and a publisher server 4.

The advertisement server 1 is operated and managed by an advertisement agent. The advertisement agent is granted, by a publisher, permission to use an image of a frame (hereinafter, referred to as frame image) and an image of a page (hereinafter, referred to as page image) included as an area of a comic book published by the publisher, and metadata such as letter information and image information included in the frame and other information on the frame (hereinafter, referred to as comic metadata). The letter information is, for example, a speech, and the image information is, for example, an image of a character. The other information includes a name of a character that appears in the frame, the number of characters, a name of a location or facility in a scene, an action of a character (running, eating, screaming, calling, etc.), feeling (delight, anger, sorrow, pleasure, etc.), an atmosphere of a frame (warm, enthusiastic, serious, glittering, etc.), a name of an object that appears in a frame (telephone, television, dish, tool, book, cake, juice, etc.), information represented by a speech or frame (positive expression on taste, positive expression on speed, etc.), and the like. The information represented by a speech or frame is used for collectively managing positive expressions on taste such as “delicious”, “good”, and “dainty”, positive expressions on speed such as “fast”, “That's fast!”, and “What a speed!”, and the like. The publisher receives royalties for the permission. By the permission, the advertisement server 1 receives the comic metadata from the publisher server 4 and stores it in a database.

Here, the advertisement server 1 may be structured as a part of an ECG (Electronic Content Guide) service provider. The ECG service refers to a service that associates various contents such as a broadcast program, a VOD (Video On Demand) program, music, a moving image, a CD, a DVD, a BD, a game, a book, a map, and store information to thereby increase opportunities for a user to approach contents. When the user has more opportunities to approach contents, “notice” of the user is evoked increasingly and actions of the user also increase, with the result that an audience rating of a program, sales of a product, and the like are expected to be improved.

The EC server 2 is operated and managed by an EC agent. The EC agent searches the advertisement server 1 for a frame or page of a comic that corresponds to a product or service that the EC agent desires to sell or provide, and purchases advertisement information in which the frame or page and an advertisement article (advertisement material) of the EC agent itself are combined (hereinafter, referred to as advertisement unit information). The advertisement agent receives, from the EC agent, royalties of the advertisement unit information that is produced by the advertisement server 1 for the EC agent.

The produced advertisement unit information is provided from the EC server 2 to the clients 3 via a network such as the Internet 10. Here, though the client 3 is typically a computer of a general consumer who purchases a product or service by the advertisement unit information, the EC server 2 also functions as a client in processing of producing the advertisement unit information by the advertisement server 1.

### [Hardware Structure of Advertisement Server]

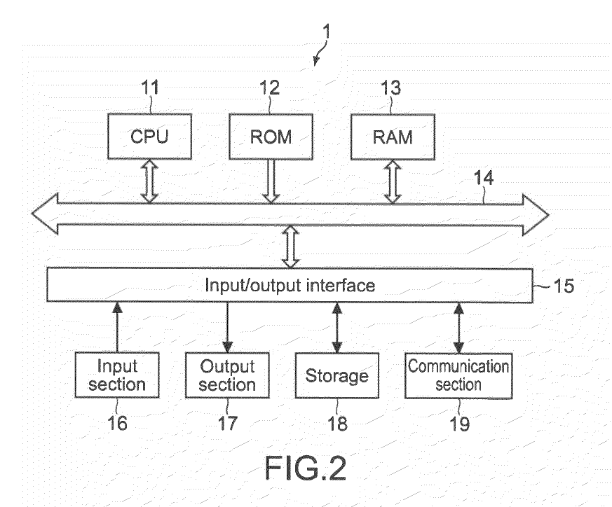

Next, a hardware structure of the advertisement server 1 will be described. FIG. 2 is a diagram showing a hardware structure of the advertisement server 1.

As shown in FIG. 2, the advertisement server 1 includes a CPU (Central Processing Unit) 11, a ROM (Read Only Memory) 12, and a RAM (Random Access Memory) 13 that are connected to each other by a bus 14. The advertisement server 1 also includes an input/output interface 15, an input section 16, an output section 17, a storage 18, and a communication section 19. The input section 16, the output section 17, the storage 18, and the communication section 19 are connected to the input/output interface 15.

The CPU 11 accesses the RAM 13 and the like as appropriate and controls the whole blocks of the advertisement server 1 integrally while performing various types of operation processing. The ROM 12 is a nonvolatile memory that fixedly stores an OS executed by the CPU 11, programs, and firmware such as various parameters. The RAM 13 is used as a work area or the like of the CPU 11 and temporarily stores the OS, various programs being executed, and various types of data being processed.

The input section 16 is a keyboard, a mouse, a touch pad, or a button, for example, and receives various operations of a user and outputs input operation signals to the CPU 11. The output section 17 is a display section of an LCD (Liquid Crystal Display) or OEL (Organic Electro-Luminescence) display that outputs video signals of various contents, a speaker that outputs audio signals of various contents, or the like.

The storage 18 is, for example, an HDD or a nonvolatile memory such as a flash memory. The storage 18 stores the OS, various programs, various types of data and programs of various databases and applications that are needed to produce the advertisement unit information and described later, in a built-in hard disk or memory device. Further, the storage 18 also stores dictionary data for associating keywords and characters described later (deriving associated keywords and associated characters). The storage 18 reads out the programs or data described above to the RAM 13.

The communication section 19 includes a network interface card or a modem, for example, and performs communication processing with other apparatuses such as the EC server 2, the clients 3, and the publisher server 4 via the network such as the Internet 10.

Since hardware structures of the EC server 2, the client 3, and the publisher server 4 are basically the same as that of the advertisement server 1, descriptions thereof are omitted. The hardware structure only needs to be a basic structure as a computer. Of course, detailed specifications may be changed arbitrarily in accordance with functions of the EC server 2, the client 3, and the publisher server 4.

### [Structure of Database Used in Advertisement System]

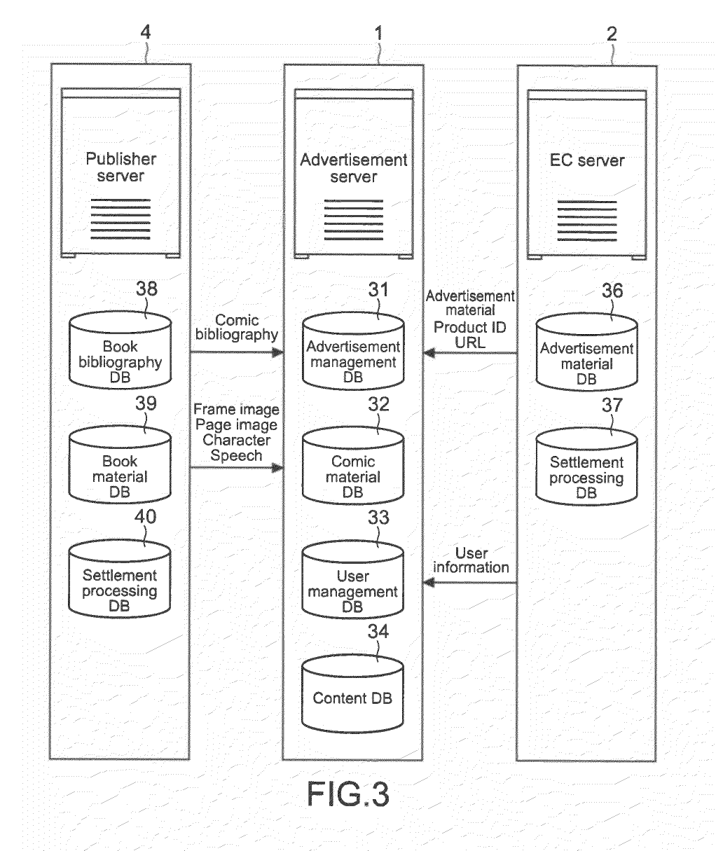

Next, a structure of a database used in the advertisement system 100 in this embodiment will be described. FIG. 3 is a diagram showing the structure of the database in the advertisement system 100.

As shown in FIG. 3, the publisher server 4 includes a book bibliography DB 38, a book material DB 39, and a settlement processing DB 40.

The book bibliography DB 38 stores bibliographic information such as titles, authors, publication dates, prices, cover images, book IDs, and summary of contents of various books including comics. The bibliographic information is generally used by the publisher server 4 for selling books on a Web site operated by itself or a Web site of a business partner. In this embodiment, out of the book bibliographic information, bibliographic information of comics is provided to the advertisement server 1 in order to produce advertisement unit information.

The book material DB 39 stores information obtained by digitizing original documents of books. Particularly in comics, the book material DB 39 stores comic material information such as a frame image and page image obtained by digitizing a frame and page included in a comic, letter information obtained by digitizing a speech or the like included in a frame, and image information obtained by digitizing an image of a character or the like included in a frame. The comic material information is also provided to the advertisement server 1 in order to produce the advertisement unit information.

The settlement processing DB 40 stores information such as a price, a name of a user (purchaser), a user ID, an address of a user, and a transportation charge that are needed for an electronic settlement in a case where a book is sold on the Web side or the like.

The EC server 2 includes an advertisement material DB 36 and a settlement processing DB 37.

The advertisement material DB 36 stores advertisement material information of a product or service that the EC agent sells through e-commerce (image of product or letter information for explaining product). The advertisement material information is provided to the advertisement server 1 in order to produce the advertisement unit information. Instead of the advertisement material information itself, the advertisement material DB 36 may store an ID of an advertisement article that appears in a Web site in which the EC server 2 provides a product or service, a URL of a page in which the advertisement article appears, or the like and provide it to the advertisement server 1. Hereinafter, such ID and URL are included in the advertisement material information.

The settlement processing DB 37 stores information such as a price, a name of a user (purchaser), a user ID, an address of a user, and a transportation charge that are needed for an electronic settlement in a case where a product or service is sold on the Web site or the like.

The advertisement server 1 includes an advertisement management DB 31, a comic material DB 32, a user management DB 33, and a content DB 34 in the storage 18.

The advertisement management DB 31 stores the comic bibliographic information received from the publisher server 4 and also stores the advertisement material information received from the EC server 2. The advertisement management DB 31 also stores information associated with produced advertisement unit information (configuration information or ID of advertisement unit information).

The comic material DB 32 stores, as comic material data, the frame image and page image (hereinafter, referred to simply as frame image in some cases) and metadata (frame metadata) including the image information of a character or the like and the letter information of a speech or the like that are received from the publisher server 4. The comic material DB 32 also contains condition information (described later) that is a condition on a combination of a comic material and an advertisement material in producing advertisement unit information and is designated by the publisher.

The user management DB 33 stores user metadata of the EC agent that manages the EC server 2 and is a user of advertisement unit information. The user metadata also contains, in addition to authentication information such as a user ID and a password, condition information (described later) that is a condition on a combination of an advertisement material and a comic material in producing advertisement unit information and is designated by the EC agent.

The content DB 34 stores information on contents associated with a comic whose material is stored in the comic material DB 32. The contents include various contents included in the ECG service, such as a movie, a drama, a game, and character goods associated with the comic.

Associated information such as the contents and metadata thereof are provided by content providers such as a broadcaster, a program distributor, a movie production company, a music distributor, and a record company, a manufacturer of products, a service provider, a merchandising company, or the like (not shown). The associated information is, for example, program information, scheduling information, group information, supplementary information, or the like in a case where a content is a broadcast program, and the association information is product information, settlement information, or the like in a case where a content is a product.

### [Operation of Advertisement System]

Next, an operation of the advertisement system 100 as structured above will be described. In descriptions below, CPUs of respective apparatuses, such as the CPU 11 of the advertisement server 1, are described as a main agent of operations. The operations are also performed in cooperation with a program executed under control of the CPUs.

### (Determination Processing of Configuration of Advertisement Unit Information)

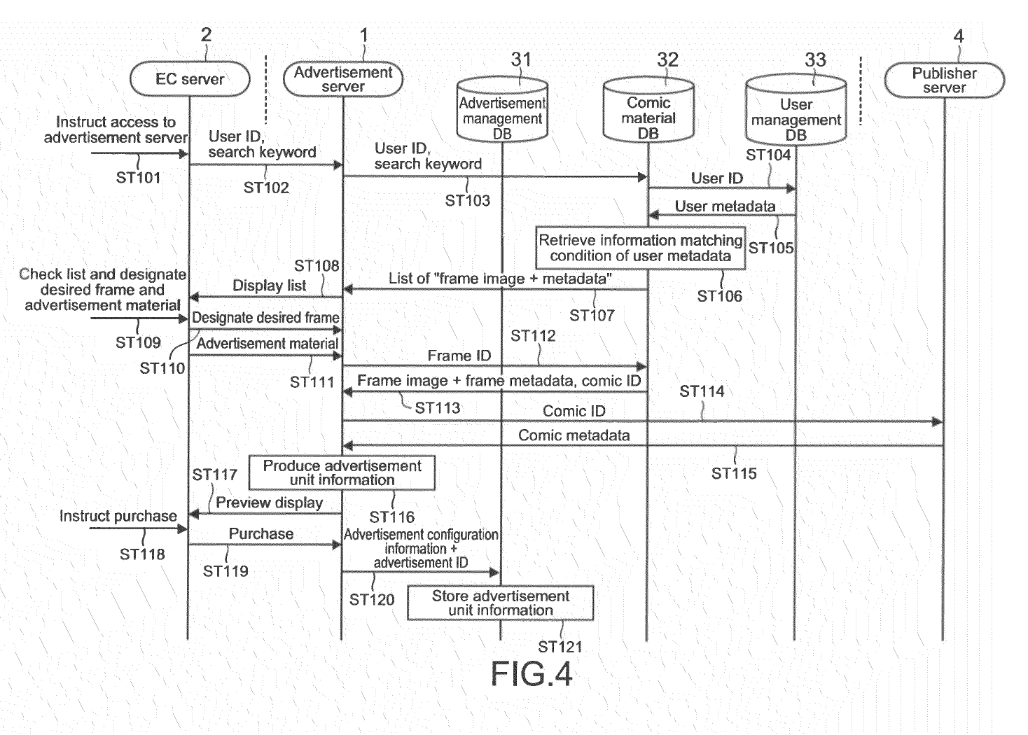

First, determination processing of configuration of advertisement unit information will be described. FIG. 4 is a sequence diagram showing a flow of processing up until when a configuration of the advertisement unit information is determined.

As shown in FIG. 4, when an instruction to access the advertisement server 1 is input from a user on the EC agent side on a browser (Step 101), the CPU of the EC server 2 first accesses the advertisement server 1 via the Internet 10. In the access, a search keyword for specifying an advertisement material of the EC agent, such a product name, a service name, a category name, and an expression of feeling, is input to the EC server 2 and transmitted to the advertisement server 1 together with a user ID necessary for user authentication (Step 102). The expression of feeling is a positive expression associated with food, such as “good”, “delicious”, and “greatest” in a case where a product as an advertisement target is food. As a keyword, the user may arbitrarily select a word that seems to be included in a speech of a comic. Further, as a keyword, the EC server 2 may transmit information indicating a facial expression of a character in a comic (for example, search request for frame in which character has delighted look on his/her face for food).

Upon reception of the user ID and search keyword from the communication section 19, after authentication processing, the CPU 11 of the advertisement server 1 transmits the user ID and search keyword to the comic material DB 32 and instructs it to perform a search (Step 103). The comic material DB 32 passes the user ID to the user management DB 33 (Step 104) and acquires user metadata (Step 105).

As described above, the user metadata contains condition information that is designated by the EC agent as to a combination of an advertisement material and a comic material in producing advertisement unit information. The condition information contains, for example, in a case where there is a comic or author that is inhibited from being associated depending on a kind of business or category of the EC agent, information for inhibiting a combination thereof. Moreover, as the condition information, information for giving priority to a combination with a specific comic or author is also contained.

As described above, the comic material DB 32 also stores the condition information designated by the publisher as to a combination of a comic and an advertisement material. The condition information contains, for example, information for inhibiting a combination with an advertisement material of a specific kind of business or product on the basis of authors or comics as a source of a comic material and adverse information for giving priority to a combination with an advertisement material of a specific kind of business or product. The comic material DB 32 retrieves a frame image and frame metadata such as a speech and a character that match the search keyword and the condition information designated by each of the EC agent and the publisher (Step 106). The comic material DB 32 then returns a list of the frame image and frame metadata that match the search keyword and the condition information, as search results, to the CPU 11 (Step 107). The list also includes a frame ID that identifies each frame image.

Subsequently, the CPU 11 transmits the list of the frame image and frame metadata to the EC server 2. That transmitted list is transmitted as a file written in a scripting language such as JavaScript and set so that, when the frame image in the list is selected in the EC server 2, the frame ID is transmitted back to the advertisement server 1. The EC server 2 displays the list on the browser (Step 108).

The user of the EC server 2 (EC agent) checks the list, selects a desired frame, and then inputs an operation of designating an advertisement material that is desired to be combined with that frame from the advertisement material DB 36 (Step 109). The advertisement material may be designated using a URL or a product ID as described above. The CPU of the EC server 2 transmits the designation of the frame image (frame ID) and advertisement material information to the advertisement server 1 (Steps 110 and 111).

The CPU 11 of the advertisement server 1 passes the received frame ID to the comic material DB 32 (Step 112) and acquires a frame image and frame metadata corresponding to that frame ID from the comic material DB 32 (Step 113). In this case, the CPU 11 also acquires a comic ID that identifies a comic including that frame image.

Subsequently, the CPU 11 transmits the comic ID to the publisher server 4 by the communication section 19 via the network (Step 114) and acquires bibliographic information of the comic (comic metadata) from the book bibliography DB 38 of the publisher server 4 (Step 115).

Then, the CPU 11 combines the advertisement material, the frame image, the frame metadata, and the comic metadata to produce advertisement unit information (Step 116). The CPU 11 transmits the produced advertisement unit information to the EC server 2 for preview display (Step 117). The CPU of the EC server 2 displays the received advertisement unit information.

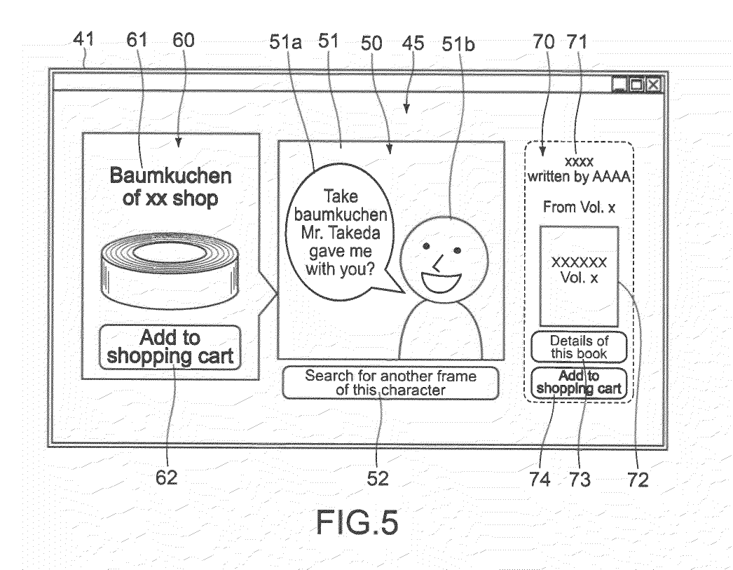

FIG. 5 is a diagram showing a display example of the produced advertisement unit information.

As shown in FIG. 5, advertisement unit information 45 is displayed on a browser 41 of the EC server 2, for example. The advertisement unit information 45 includes a frame image area 50, an advertisement material area 60, and a comic bibliography area 70.

The frame image area 50 includes a frame image 51 including a speech area 51a and a character image area 51b, and a character link button 52.

The advertisement material area 60 includes an advertisement image 61 showing an advertised product or the like and a purchase button 62 for executing purchase processing of the advertised product. The purchase button 62 is set so that upon being pressed, a product ID for identifying the advertised product is transmitted to the EC server 2 and a settlement is started.

Though described later, the character link button 52 is a button for executing processing of displaying another frame in which the character appears and advertisement unit information 45 corresponding thereto (character link processing). Further, a link function is also embedded in the speech area 51a and set so that when the speech area 51a is selected, another speech associated with a keyword included in the speech area 51a and advertisement unit information 45 corresponding thereto or information associated with another content are displayed (speech link processing).

The comic bibliography area 70 includes a comic name/author information 71, a comic thumbnail image 72, a detail display button 73, and a purchase button 74. The comic thumbnail image 72 is a cover image of a comic, for example. The detail display button 73 is a button for displaying information that introduces a character and a plot of the comic. The purchase button 74 is set so that upon being pressed, a comic ID for identifying the comic is transmitted to the publisher server 4 and a settlement is started.

Though not shown, a purchase button for inputting whether to purchase the advertisement unit information as the preview display target is displayed on the browser 41.

The layout or user interface of the frame image area 50, the advertisement material area 60, and the comic bibliography area 70 is of course not limited to that shown in FIG. 5 and may be modified arbitrarily.

In the example of FIG. 5, the advertisement image 61 that advertises a baumkuchen is displayed in the advertisement material area 60, whereas the frame image 51 that includes letters of “baumkuchen” in the speech area 51a is displayed in the frame image area 50 in accordance with the advertisement image 61. Further, a comic displayed in the comic bibliography area 70 is a comic including the frame image 51.

Referring back to FIG. 4, the user of the EC server 2 checks the preview display of the advertisement unit information and when the user instructs the purchase by the purchase button (Step 118), the EC server 2 transmits the purchase instruction to the advertisement server 1 (Step 119).

Upon receiving the purchase instruction, the CPU 11 of the advertisement server 1 stores configuration information (combination information) of the advertisement unit information 45, together with an advertisement ID for identifying the advertisement unit information 45, in the advertisement management DB 31 (Steps 120 and 121). In this storage processing, only combination information of the frame image area 50, the advertisement material area 60, and the comic bibliography area 70 may be stored, or the advertisement unit information 45 itself in a state where those areas are combined may be stored.

Further, in a case of a system in which the EC agent makes settlement on the basis of the advertisement unit information with respect to an advertisement-unit-information-providing service by the advertisement server 1, settlement processing is performed between the advertisement server 1 and the EC server 2 after the storage processing. In a case where the service is used on a monthly basis or yearly basis, the settlement processing is separately made.

### (Advertisement-Unit-Information-Providing Processing)

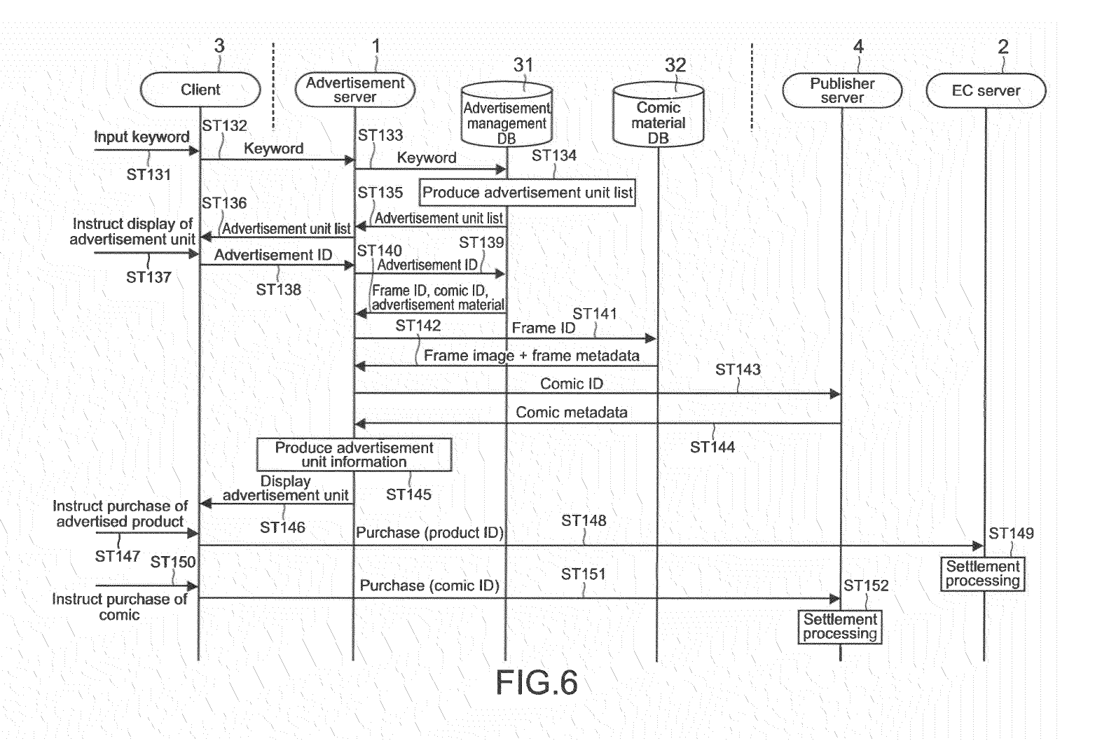

Next, processing in which the advertisement unit information purchased by the EC agent is provided to the client 3 (general consumer) will be described. FIG. 6 is a sequence diagram showing a flow of advertisement-unit-information-providing processing.

As shown in FIG. 6, when a user of the client 3 first inputs a search of a desired product by a keyword on an operation site of the EC agent, for example, (Step 131), the client 3 transmits the keyword to the advertisement server 1 (Step 132).

The CPU 11 of the advertisement server 1 passes the received keyword to the advertisement management DB 31 (Step 133) to produce a list of the advertisement unit information 45 associated with the keyword (Step 134) and acquires the list (135). The list of the advertisement unit information 45 is constituted of a text or thumbnail indicating the advertisement unit information 45, for example, and is produced based on the frame metadata stored in the advertisement management DB 31. The CPU 11 transmits, to the client 3, the advertisement unit information list in a state of being displayed as a banner on a browser of the client 3 (Step 136). An advertisement ID of each piece of advertisement unit information 45 is embedded in the advertisement unit information list as a script and is set so as to be sent back to the advertisement server 1 when the user selects one piece of the advertisement unit information 45 from the list.

When the user of the client 3 inputs an operation for selecting and displaying one advertisement unit from the displayed advertisement unit information list (Step 137), the CPU of the client 3 transmits an advertisement ID of the selected advertisement unit information 45 to the advertisement server 1 (Step 138).

Based on the received advertisement ID, the CPU 11 of the advertisement server 1 acquires a frame ID, comic ID, and advertisement material of the corresponding advertisement unit information 45 from the advertisement management DB 31 (Steps 139 and 140). Further, based on the frame ID, the CPU 11 acquires a frame image and frame metadata of the corresponding advertisement unit information from the comic material DB 32 (Steps 141 and 142). Moreover, the CPU 11 transmits the comic ID to the publisher server 4 and acquires comic metadata (Steps 143 and 144).

The above processing in Steps 139 to 144 are unnecessary in a case where the advertisement management DB 31 stores not the combination information but the advertisement unit information 45 in a combined state. In this case, the CPU 11 only needs to acquire the advertisement unit information 45 from the advertisement management DB 31 based on the advertisement ID.

Subsequently, based on the acquired frame image, frame metadata, advertisement material, and comic metadata, the CPU 11 produces advertisement unit information 45 (Step 145) and transmits it to the client 3 in order to display it on the browser of the client 3 (Step 146). The advertisement unit information 45 displayed on the browser of the client 3 is the same as that shown in FIG. 5.

In a case where the user gives instruction to purchase an advertised product by the purchase button 62 of the advertisement material area 60 on the displayed advertisement unit information 45 (Step 147), a product ID is transmitted to the EC server 2 (Step 148) and settlement processing of the advertised product is executed (Step 149).

Similarly, in a case where the user gives instruction to purchase a comic by the purchase button 74 of the comic bibliography area 70 (Step 150), a comic ID is transmitted to the publisher server 4 (Step 151) and settlement processing of the comic is executed (Step 152).

(Link Processing from Advertisement Unit Information)

As described above, the advertisement unit information 45 has a function of executing not only the settlement processing of an advertised product and a comic but also a link to another piece of the advertisement unit information 45. Hereinafter, the link processing will be described. The link processing includes the speech link processing and the character link processing as described above.

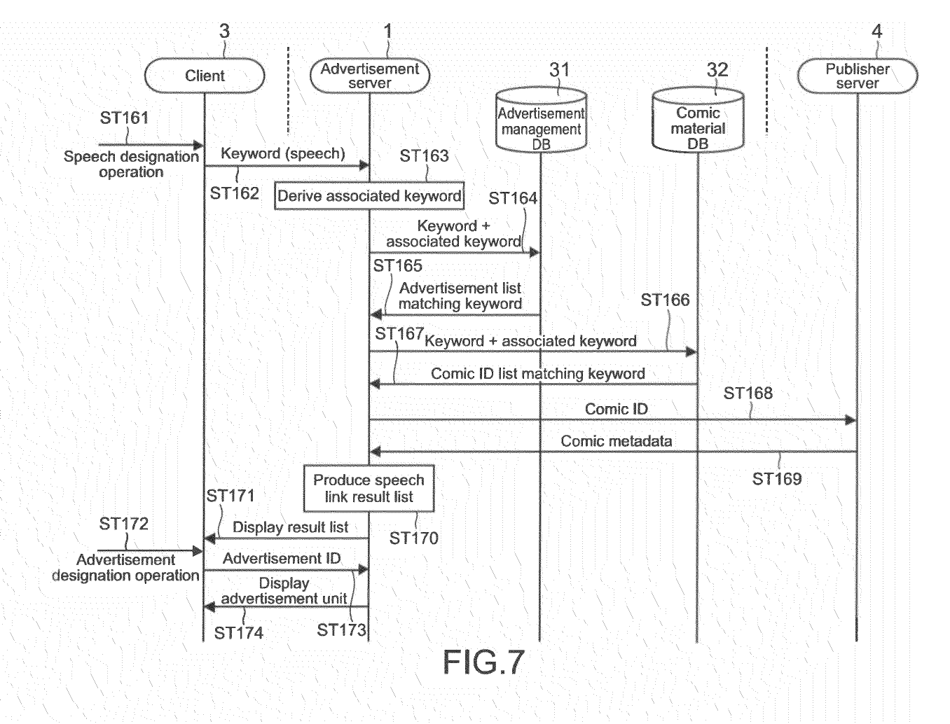

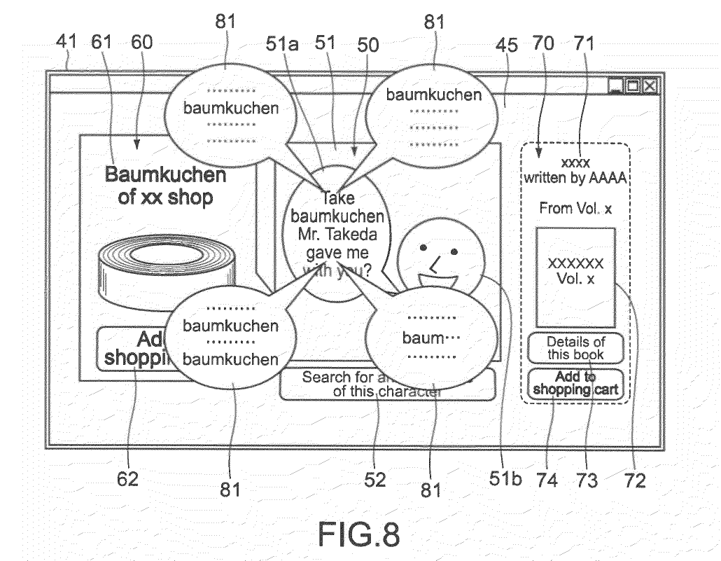

First, the speech link processing will be described. FIG. 7 is a sequence diagram showing a flow of the speech link processing, and FIG. 8 is a diagram showing a display example of a screen during execution of the speech link processing.

As shown in FIG. 7, when an operation of designating the speech area 51a is input on the advertisement unit information 45 displayed in the client 3 (Step 161), the client 3 transmits a keyword or speech embedded in the speech area 51a to the advertisement server 1 (Step 162).

The CPU 11 of the advertisement server 1 derives a keyword associated with the received keyword based on a keyword dictionary or the like (Step 163). Then, based on the keyword and the associated keyword, the CPU 11 acquires a list of advertisement unit information 45 matching the keyword and the associated keyword from the advertisement management DB 31 (Steps 164 and 165).

Moreover, based on the keyword and the associated keyword, the CPU 11 acquires a list of comic IDs matching the keyword and the associated keyword from the comic material DB 32 (Steps 166 and 167). Further, based on the comic IDs, the CPU 11 acquires comic metadata corresponding to the comic IDs from the publisher server 4 (Steps 168 and 169).

Then, the CPU 11 produces a list of speeches as link targets (speech link result list) based on the acquired comic metadata (Step 170) and transmits the speech link result list to the client 3 (Step 171). At this time, the advertisement server 1 produces advertisement unit information 45 and makes a list thereof based on the acquired list of advertisement unit information 45 and comic metadata. A script by which, when a speech is selected, advertisement unit information 45 including an advertisement ID corresponding to the speech is displayed is embedded in the speech link result list.

The transmitted speech link result list is displayed like speech bubbles coming out of the speech area 51a serving as a link source as shown in FIG. 8, for example.

One of speeches 81 that constitute the speech link result list is designated by the user (Step 172), an advertisement ID corresponding to that speech 81 is transmitted to the advertisement server 1 (Step 173). Then, the advertisement server 1 transmits the advertisement unit information 45 corresponding to that advertisement ID to the client 3 to display it (Step 174).

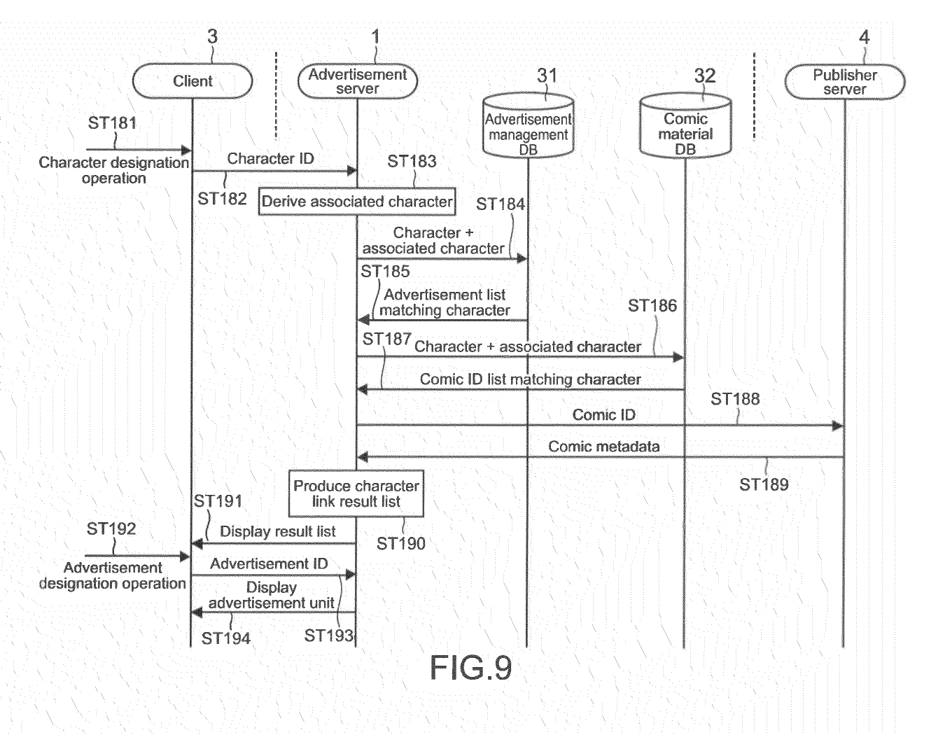

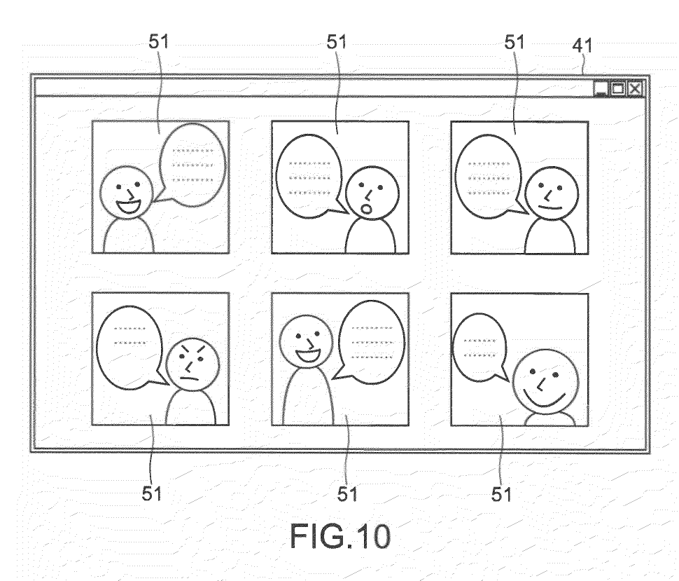

Next, the character link processing will be described. FIG. 9 is a sequence diagram showing a flow of the character link processing, and FIG. 10 is a diagram showing a display example of a screen during execution of the character link processing.

Since the flow of the character link processing (Steps 181 to 194) is basically the same as that of the speech link processing (Steps 161 to 174) shown in FIG. 7, descriptions thereof are omitted. Associated characters are derived in Step 183 of FIG. 9 by a dictionary or the like constituted of metadata showing attributes of a character image.

As shown in FIG. 10, a character link result list is constituted of lists of frame images 51 that include a character image coinciding with or associated with a source character, for example. An advertisement ID is also embedded in each frame image 51 of the character link result list. When the user of the client 3 selects any of the frame images 51, corresponding advertisement unit information 45 is transmitted from the advertisement server 1 to the client 3 and displayed. Moreover, as the character link result list, a list in which pieces of advertisement unit information 45 shown in FIG. 5 are arranged may be displayed. Accordingly, since the user notices not only the character but also an advertisement image 61 associated with the character at a time, more user's appetite for purchasing is evoked.

### [Summary]

As described above, according to this embodiment, the advertisement server 1 produces advertisement unit information 45 by combining an advertisement material and a frame of a comic, with the result that a high-value-added advertisement that effectively utilizes a unique perspective of the world of the comic can be provided. Further, the advertisement server 1 incorporates the comic bibliographic information into the advertisement unit information 45, with the result that advertisement unit information 45 having a surprising combination can be provided to both a user that searches for an advertised product and a user that searches for a comic. Accordingly, an advertising effect can be increased much more than a case where an advertised product and a comic are advertised separately, which can thus contribute to sales of both the advertised product and the comic.

In addition, the advertisement server 1 can lead a user interested in a specific product to another product via a speech or character of a comic by linking pieces of advertisement unit information 45 from one another based on the speech or character, which can contribute to an increase of the sales.

### Modified Examples

The present invention is not limited to the above embodiment and can be variously modified without departing from the gist of the present invention.

In the above embodiment, the advertisement unit information 45 is purchased by the EC agent but may be purchased by an affiliate user. In this case, a usage fee of the advertisement unit information may not be collected. In this case, the affiliate user him/herself does not have an advertisement material. Therefore, for example, the user may designate a product that is desired to be included in his/her Web site by a URL etc. of a Web site of an EC agent or the like, transmit it to the advertisement server 1, and through communication with the advertisement server 1 as in the case of the above embodiment, determine a frame image to be combined with that product.

Further, the advertisement unit information 45 may be purchased by the publisher. In this case, the flows of the processing of the publisher server 4 and the processing of the EC server 2 become reverse to those shown in FIG. 4 and all that remains is to perform the same processing to thus produce the advertisement unit information 45. In the condition information in this case, a product or the like that is not to be combined with a comic is designated in accordance with circumstances of the publisher side.

In the above embodiment, the example in which a frame image of a comic is combined with an advertisement material and advertisement unit information 45 is thus produced has been described, but the advertisement material may be combined with two or more frame images or one or more page images to thus produce the advertisement unit information 45.

In the above embodiment, the example in which the link is made from a speech or character and another advertisement unit information 45 is thus displayed has been described. However, in addition to this, it may be possible to display information on another content associated with a comic or comic metadata via a speech or character and thus allow access to that content. In this case, when an operation of designating a speech or character is input on the advertisement unit information 45, the CPU 11 of the advertisement server 1 may retrieve a content associated with the comic or comic metadata by a keyword or the like based on the content DB 34 and display it. For example, a link may be made to a content associated with the comic, such as another product (CD, DVD, book, food, etc.) or service (program, article of Web site) that is retrieved with a title of comic, an author name, a character name, etc. being keywords. Moreover, a link may be made to a content that is not directly associated with the comic but associated with the comic metadata, such as a comic retrieved with a keyword included in a speech, another product or service, etc.

In the above embodiment, the advertisement management DB 31 and the comic material DB 32 are provided in the advertisement server 1 and the book bibliography DB 38 is provided in the publisher server 4, from which bibliographic information on comic materials is stored in the comic material DB 32 of the advertisement server 1. However, locations where the respective databases are provided may not be limited basically as long as the databases can be accessed from the advertisement server 1, the EC server 2, and the publisher server 4. For example, the advertisement server 1 may acquire all data necessary for producing advertisement unit information 45 in advance from the publisher server 4 or the like and hold it. Further, the publisher server 4 may have the function of the advertisement server 1 and the advertisement server 1 may not exist. In other words, the EC server 2 and the publisher server 4 may directly exchange data and combine advertisement materials thereof to thereby produce advertisement unit information 45.

In the above embodiment, the example in which one advertisement material and one frame image are combined (FIG. 5) has been described. However, one advertisement material and a plurality of frame images may be combined to produce advertisement unit information 45.

In this case, the EC server 2 or the publisher server 4 designates a plurality of frames (transmits a plurality of frame IDs) in Step 110 of FIG. 4. Based on the frame IDs, the advertisement server 1 combines a plurality of frame images and pieces of comic bibliographic information corresponding thereto and produces advertisement unit information 45.

Further, by designating metadata that brings together a plurality of frames (for example, book name, character name, and feeling expression like “delicious”) instead of designating the plurality of frames, a plurality of frame images and an advertisement material may be combined accordingly.

In this case, as a search keyword transmitted from the EC server 2 or the publisher server 4 in Step 102 of FIG. 4, metadata that brings together a plurality of frames is transmitted, for example. Moreover, an advertisement material to be combined is also transmitted at this time. The advertisement server 1 retrieves a plurality of frame images matching that search keyword and each condition information and combines the plurality of frame images and the advertisement material, to thereby produce advertisement unit information. In this case, a list of the frame images and frame metadata may not be presented to the EC server 2 or the publisher server 4, or may be presented and then arbitrarily received or rejected by the EC server 2 side or the publisher server 4 side.

In a case where the advertisement unit information 45 produced based on the plurality of frame images is provided to the client 3, those pieces of advertisement unit information 45 may be displayed as a list or displayed sequentially in a display area in a form of a slide show.

Moreover, in a service in which user information of a user of the client 3 is managed by the advertisement server 1 (service in which advertisement server 1 is logged in using user ID and password), in a case where the advertisement server 1 recognizes that the user has viewed advertisement unit information 45 including a certain advertisement ID and when the user gives instruction to show advertisement unit information 45 including the same advertisement ID next time, the advertisement server 1 may produce and display advertisement unit information 45 in which a frame image and an advertisement material that are different from those in the previous time are combined.

In addition, in a case where the advertisement server 1 manages user's preference information as user information, advertisement unit information 45 in which a frame image matching the preference information (for example, favorite character, favorite atmosphere, favorite author, etc. of user) is preferentially used may be produced.

In the above embodiment, the advertisement unit information 45 that is retrieved by the advertisement server 1 with the use of a keyword input by the user of the client 3 is presented. However, instead of a keyword, a frame image itself may be used as a search key.

In this case, the advertisement server 1 presents a list of representative frames selected in advance on a Web site of the EC agent or the like, as in the case of the list shown in FIG. 10, for example. The user of the client 3 selects one or a plurality of desired frame images from the presented list of frame images. Then, a frame ID of the selected frame image is transmitted from the client 3 to the advertisement server 1. By setting one or pieces of comic metadata associated with the received one or plurality of frame IDs as search keyword, the advertisement server 1 retrieves a frame image and a comic matching the search keyword and condition information from the comic material DB 32 to produce the advertisement unit information 45, and presents it to the user.

More specifically, for example, when the user of the client 3 searches for a desired comic on the Web, a list of representative frame images that are selected by the advertisement server 1 in advance and from which an atmosphere of the comic can be known is presented to the user as options so that the user does not need to think of a keyword. Upon receiving the selection of a frame image from the user, the advertisement server 1 retrieves a comic having an atmosphere (for example, warm etc.) similar to that of the frame image selected by the user and combines bibliographic information, a frame image, and an advertisement material of the comic having a similar atmosphere to thereby present it as advertisement unit information 45.

In the above embodiment, the example in which a frame image of a comic and an advertisement material are combined to produce the advertisement unit information 45 has been described. However, a part of all contents including other digital books such as a magazine, a picture book, a photo collection book, a novel with an illustration, a poetry book, an art collection book, a technical book, and a map, a video, and a Web site and an advertisement material may be combined to produce advertisement unit information 45. That is, the present invention is applicable to any content as long as the content has image information corresponding to an image of a comic and text information corresponding to a speech of the comic as visible (direct) information and has the feature that metadata (indirect metadata) as invisible information can be added, as in the case of a comic.

In this case, examples of the “part of contents” may include an article and a photo of a magazine, a text and an illustration of a novel, a poem of a poetry book, a photo and a text of a picture book and photo collection book, a painting and a text of an art collection book, a text and an illustration of a technical book, a part of a map, a text and an image of a Web site, and a scene of a video.

### Another Embodiment 1

Next, another embodiment of the present invention will be described.

In the above embodiment, the example in which a frame or a page of a comic is combined with an advertisement material has been described. However, in this embodiment, an advertisement material is combined with a page of a comic. The comic in this case is a digital comic that can be viewed for free on the Web, for example, under condition of insertion of an advertisement. In this embodiment, the advertisement material is set so as to change while linking contents of a page of the comic.

This page-content-linking advertisement system can be executed by the advertisement server 1, the EC server 2, the client 3, and the publisher server 4 as in the case of the above embodiment. A hardware structure necessary for the advertisement server 1, the EC server 2, the client 3, and the publisher server 4 may be the same as that shown in FIG. 2.

In this embodiment, the EC agent pays cost to run an advertisement to the advertisement agent that operates the advertisement server 1 in order to run the advertisement thereof. The advertisement server 1 pays royalties to the publisher and uses digital comic data of the publisher server 4. The usage fee of the comic data may be directly paid from the EC agent or the like serving as an advertiser or the cost to run the advertisement that is paid to the advertisement agent may be partially paid to the publisher.

In this embodiment, the advertisement server 1 stores, in the storage 18, a product, a service, etc. that may be associated with (or inhibited to be associated with) a comic by the publisher, as condition information. Further, it is assumed that the advertisement material is transmitted to the advertisement server 1 from the EC server 2 in advance and stored in the advertisement management DB 31. Descriptions of other portions common to the above embodiment will be omitted.

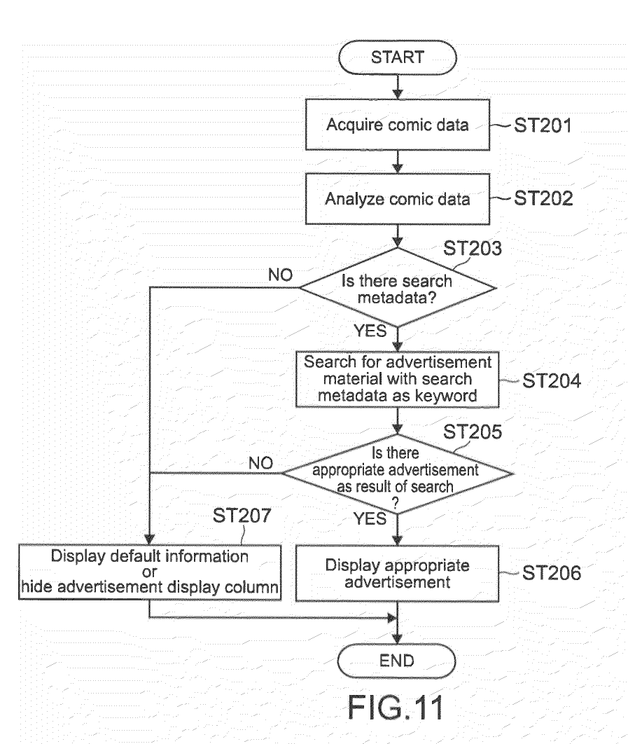

FIG. 11 is a flowchart showing a flow of an operation of the page-content-linking advertisement system in this embodiment.

As shown in FIG. 11, the CPU 11 of the advertisement server 1 first acquires page data of a digital comic in a case where a user of the client 3 opens a first page of the digital comic or turns a page on a browser (Step 201). Subsequently, the CPU 11 analyzes contents of metadata such as a speech and a character of the page data (Step 202).

In a case where it is judged that search metadata is present as the result of the analysis, the CPU 11 searches for an advertisement material stored in the advertisement management DB 31, with the search metadata being used as a keyword (Step 204). In this case, filtering by the condition information described above is executed.

In a case where an appropriate advertisement material is retrieved as the result of the search (YES of Step 205), the CPU 11 displays the appropriate advertisement material in a predetermined column of the digital comic (Step 206). In a case where the appropriate advertisement material is not retrieved (NO of Step 205), the CPU 11 displays a default advertisement that is not linked to the page contents (Step 207). Alternatively, the CPU 11 may hide the advertisement display column in this case.

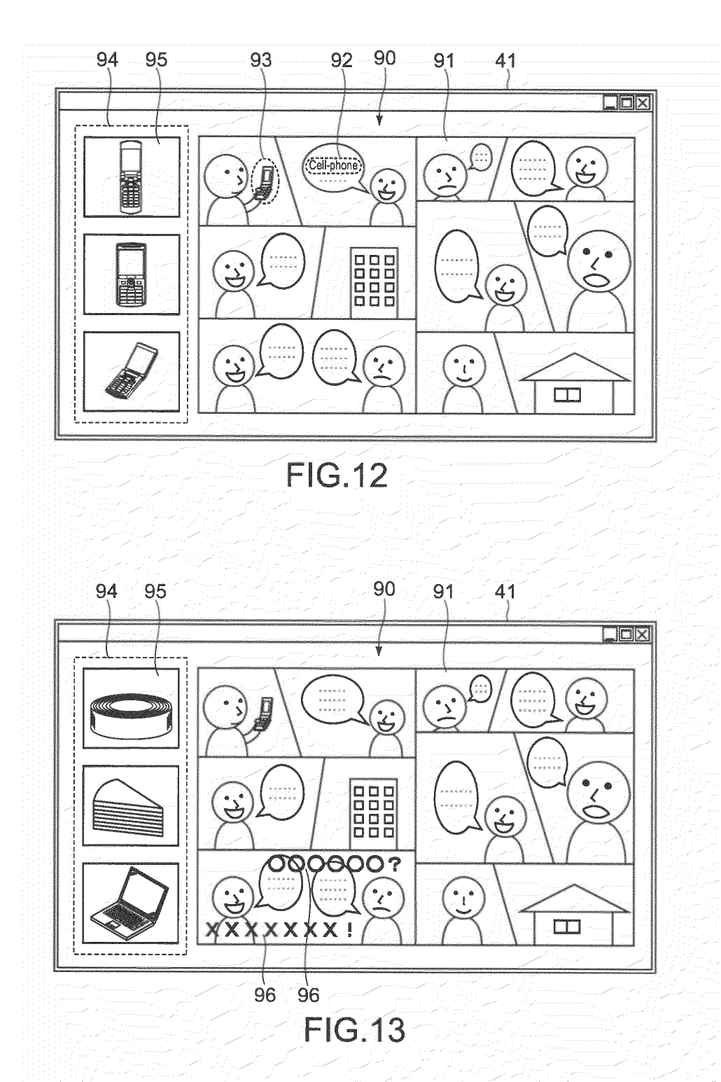

FIG. 12 is a diagram showing a display example of comic data and an advertisement material displayed in the page-content-linking advertisement system.

As shown in FIG. 12, a search keyword 92 of “cell-phone” is extracted from a speech of a page data 91 of a comic, for example. Further, by analyzing not only the speech but also an image 93 in which a character holds a cellular phone, a search keyword of “cellular phone” may be extracted. Moreover, the advertisement server 1 may hold metadata corresponding to each image of each page data 91 as database in advance and adopt the metadata as a search keyword in synchronization with a timing at which a page is turned.

Then, based on the search keyword, an advertisement material 95 is displayed in an advertisement display column 94 on the left-hand side of the page data, for example. In the FIG. 12, an advertisement material 95 of a cellular phone associated with the search keyword “phone” or “cellular phone” is displayed.

The CPU 11 may execute a retrieval of the advertisement material in real time each time a page is turned, or may retrieve a keyword in advance from data corresponding to all pages or a specific page of the comic and determine a display target advertisement material in advance.

As described above, the advertisement server 1 displays an advertisement material that is linked to page contents of a comic together with a page of the comic. Accordingly, a user who views the comic tends to become interested in the advertisement as compared to a case where contents of the comic and the advertisement material do not have any association, with the result that more user's appetite for purchasing is likely to be evoked.

The page-content-linking advertisement system described above may be executed directly by the publisher server 4 that retains the digital comic without intermediation of the advertisement server 1.

### Another Embodiment 2

Next, still another embodiment of the present invention will be described. In this embodiment, descriptions of portions that have the same structure as that of Another embodiment 1 described above will be omitted. FIG. 13 is a diagram showing a display example of comic data and an advertisement material displayed in this embodiment.

As shown in FIG. 13, in this embodiment, the advertisement material 95 is displayed in the advertisement display column 94 provided adjacently to the page data 91 of the comic, which is the same as in Another embodiment 1 described above. However, in this embodiment, the advertisement material is not linked to the page contents and is arbitrarily inserted by the user. In other words, a plurality of users of the client 3 who are viewing the digital comic transmit advertisement materials held by themselves to the advertisement server 1 from the client 3 and thus insert the advertisement materials one by one into opened advertisement display columns 94. In addition, the plurality of users can insert letter information 96 of their own comments etc. into the page of the comic via the client 3.

In a case where the comic is distributed as a program, for example, the advertisement server 1 may perform time control such that the comments are displayed at a timing at which a viewer ends to read one frame or one page.

As described above, according to this embodiment, the advertisement server 1 can enhance user's interests different from a case where a user merely views a comic, by the user arbitrarily participating and adding advertisement materials or comments to a comic.

The present application contains subject matter related to that disclosed in Japanese Priority Patent Application JP 2009-096228 filed in the Japan Patent Office on Apr. 10, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A server apparatus, comprising:
a first storage to store an area image that is extracted from at least one area included in a content and first metadata that indicates information on the area in association with each other;
a second storage to store advertisement material information on one of a product and a service;
a communication section to receive first input information that is input in a client apparatus to search for one of the product and the service, from the client apparatus via a network; and
a controller to extract the first metadata associated with the received first input information and produce combined advertisement information by combining the area image associated with the extracted first metadata and the stored advertisement material information with each other, the combined advertisement information being to be displayed in the client apparatus.

2. The server apparatus according to claim 1,
wherein the communication section receives second metadata indicating attribute information of the content from an external apparatus via the network, and
wherein the controller produces the combined advertisement information so that the received second metadata is displayed together with the area image and the advertisement material information in the client apparatus.

3. The server apparatus according to claim 2,
wherein the area includes one of image information and letter information,
wherein the first metadata indicates information on one of the image information and the letter information,
wherein the first storage plurally stores the area image and the first metadata in association with each other,
wherein the communication section transmits the produced combined advertisement information together with the first metadata to the client apparatus so that the produced combined advertisement information is displayed in the client apparatus,
wherein the communication section receives, from the client apparatus, first designation information that designates one of the image information and the letter information included in the combined advertisement information displayed in the client apparatus based on the transmitted first metadata, and
wherein the controller separately produces, based on the received first designation information, the combined advertisement information associated with the first designation information and transmits the separately-produced combined advertisement information to the client apparatus by the communication section.

4. The server apparatus according to claim 2, further comprising:
a third storage to store third metadata on a different content associated with one of the content and the first metadata in association with the second metadata,
wherein the communication section receives, from the client apparatus, second designation information that designates the second metadata included in the combined advertisement information displayed in the client apparatus,
wherein the controller transmits, based on the received second designation information, the third metadata associated with the second metadata to the client apparatus by the communication section so that the third metadata is linked from the second metadata and displayed.

5. The server apparatus according to claim 2, further comprising:
a third storage to store condition information that indicates a condition on a combination of the advertisement material information and a pair of the area image and the second metadata,
wherein the controller produces the combined advertisement information based on the condition information.

6. The server apparatus according to claim 2,
wherein the controller produces a list of the area images associated with the first input information before the combined advertisement information is produced,
wherein the controller transmits the produced list to the client apparatus by the communication section,
wherein the controller receives selection information that indicates a selection of at least one area image from the transmitted list and the advertisement material information to be stored in the second storage from the client apparatus by the communication section, and
wherein the controller produces the combined advertisement information based on the received selection information and the received advertisement material information.

7. A method of producing advertisement information, comprising:
storing an area image that is extracted from at least one area included in a content and first metadata that indicates information on the area in association with each other;
storing advertisement material information on one of a product and a service;
receiving input information that is input in a client apparatus to search for one of the product and the service, from the client apparatus via a network;
extracting the first metadata associated with the received input information; and
producing combined advertisement information that is displayed in the client apparatus by combining the area image associated with the extracted first metadata and the stored advertisement material information with each other.

8. A program causing a server apparatus to execute:
a step of storing an area image that is extracted from at least one area included in a content and first metadata that indicates information on the area in association with each other;
a step of storing advertisement material information on one of a product and a service;
a step of receiving input information that is input in a client apparatus to search for one of the product and the service, from the client apparatus via a network;
a step of extracting the first metadata associated with the received input information; and
a step of producing combined advertisement information that is displayed in the client apparatus by combining the area image associated with the extracted first metadata and the stored advertisement material information with each other.
